(19) United States
(12) Patent Application Publication
(10) Pub. No.: US 2025/0212021 A1
(43) Pub. Date: Jun. 26, 2025

(54) ADAPTIVE MULTI-AP COORDINATION MODE SELECTION BASED ON STREAM CLASSIFICATION SERVICE

(71) Applicant: Cisco Technology, Inc., San Jose, CA (US)

(72) Inventors: Malcolm M. SMITH, Richardson, TX (US); Indermeet S. GANDHI, San Jose, CA (US); Binita GUPTA, San Diego, CA (US)

(21) Appl. No.: 18/929,539

(22) Filed: Oct. 28, 2024

Related U.S. Application Data
(60) Provisional application No. 63/613,671, filed on Dec. 21, 2023.

(51) Int. Cl. H04W 24/02

(52) U.S. Cl. CPC H04W 24/02

(57) ABSTRACT

Techniques for adaptive multi-AP coordination mode selection are provided. The first AP receives one or more network quality targets for a traffic flow between the first AP and a first station (STA). The first AP selects a first channel coordination mode based on the one or more network quality requirements. Responsive to the implementation of the first mode, the first AP receives performance metrics of the traffic flow under the first mode from the first STA. Upon detecting that a degradation in the performance metrics of the traffic flow, the first AP requests the first STA to monitor interference impacts on the performance metrics of the traffic flow caused by a plurality of other STAs. The first AP decides an adjustment on network configurations of the first AP.

### CROSS-REFERENCE TO RELATED APPLICATIONS

This application claims benefit of co-pending U.S. provisional patent application Ser. No. 63/613,671 filed Dec. 21, 2023. The aforementioned related patent application is herein incorporated by reference in its entirety.

### TECHNICAL FIELD

Embodiments presented in this disclosure generally relate to wireless communication. More specifically, embodiments disclosed herein relate to methods of adaptively adjusting multi-AP coordination (MAPC) mode selection.

### BACKGROUND

Stream Classification Service (SCS) provides reliability and latency targets for individual traffic flows. These targets can be partly met by individual access points (APs). However, when multiple APs are involved, Multi-AP Coordination (MAPC) operations present challenges, especially when spatial reuse (SR) modes like MAPC-SR, MAPC-FDMA (Frequency Division Multiple Access), and MAPC-OFDMA (Orthogonal Frequency Division Multiple Access) are used. These modes may compromise the quality of the traffic streams, leading to failures in meeting the reliability or latency targets determined through the SCS according to the streams' Quality of Service (QoS) characteristics.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment that supports adaptive adjustment of MAPC mode, according to some embodiments of the present disclosure.

FIG. 2 depicts an example process for adjusting MAPC mode based on specific interference monitoring, according to some embodiments of the present disclosure.

FIG. 3 depicts an example process for adjusting MAPC mode based on general interference monitoring and ML analysis, according to some embodiments of the present disclosure.

FIG. 4 depicts an example method of an AP selecting and adjusting MAPC mode based on identified SCS targets and interference monitoring, according to some embodiments of the present disclosure.

FIG. 5 is a flow diagram depicting an example method for AP model selection and adjustment, according to some embodiments of the present disclosure.

FIG. 6 depicts an example AP supporting dynamic AP mode adjustment, according to some embodiments of the present disclosure.

FIG. 7 depicts an example client device supporting dynamic AP mode adjustment, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a first access point (AP), identifying, by a first access point (AP), one or more network quality targets for a traffic flow between the first AP and a first station (STA), selecting, by the first AP, a first channel coordination mode, from a set of available channel coordination modes, based on the one or more network quality targets, responsive to implementing of the first channel coordination mode, receiving, by the first AP, performance metrics of the traffic flow under the first channel coordination mode from the first STA, upon detecting a degradation in the performance metrics of the traffic flow, requesting, by the first AP, the first STA to monitor interference impacts on the performance metrics of the traffic flow caused by a plurality of other STAs, and deciding an adjustment on network configurations of the first AP.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### Example Embodiments

The present disclosure provides techniques for selecting and adjusting MAPC mode based on identified SCS targets for traffic flows and the results of detailed interference monitoring.

As used herein, SCS targets refer to specific performance requirements that network traffic should meet or exceed to ensure optimal service delivery. The SCS targets are identified through the SCS based on the types of the traffic flows and their QoS requirements and may include, but are not limited to, reliability targets, latency targets, or throughput targets. Different types of traffic flow may have varying QoS requirements, leading to the assignment of different SCS targets. For example, real-time video conferencing relies on both high reliability and low latency, while file download may rely on high reliability but has low priority for latency.

To meet these targets for various traffic flows, each AP may implement detailed QoS strategies, adjusting transmission power, scheduling, and prioritizing to meet the specific needs of each type of traffic. However, in situations involving multiple APs, network traffic management becomes significantly more complex through multi-AP coordination (MAPC). The MAPC modes, including but not limited to MAPC-SR (utilizing different spatial channels), MAPC-TDMA (utilizing time-division multiple access), MAPC-FDMA (dividing the frequency band), and MAPC-OFDMA (utilizing orthogonal frequency-division multiple access), are designed to enhance the overall capacity and efficiency of the network. While these strategies improve the network throughput and reduce interference, they can also present challenges in meeting the precise reliability and latency targets required by certain traffic flows. Specifically, traffic that relies on high reliability may not be well-served by modes like MAPC-SR, where variance in signal-to-interference-plus-noise ratio (SINR) in this mode may cause errors that degrade the service level agreement (SLA). Conversely, traffic flows with stringent latency requirements might find MAPC-SR advantageous since it allows AP to exploit early transmission opportunities (TXOPs).

Embodiments of the present disclosure introduce a mechanism or system that enables APs to dynamically select MAPC modes, considering the per-stream latency or reliability targets (or requirements) identified from QoS traffic characteristics. The system evaluates the compatibility of each MAPC mode with the QoS requirements of individual traffic flows to ensure that selections are optimal (or at least improved) for both network efficiency and service quality. By intelligently matching MAPC modes to the specific needs of SCS-classified traffic streams, the disclosed embodiments improve the network performance of the traffic streams, therefore addressing the challenges caused by diverse network demands and the inherent complexities of multi-AP environments.

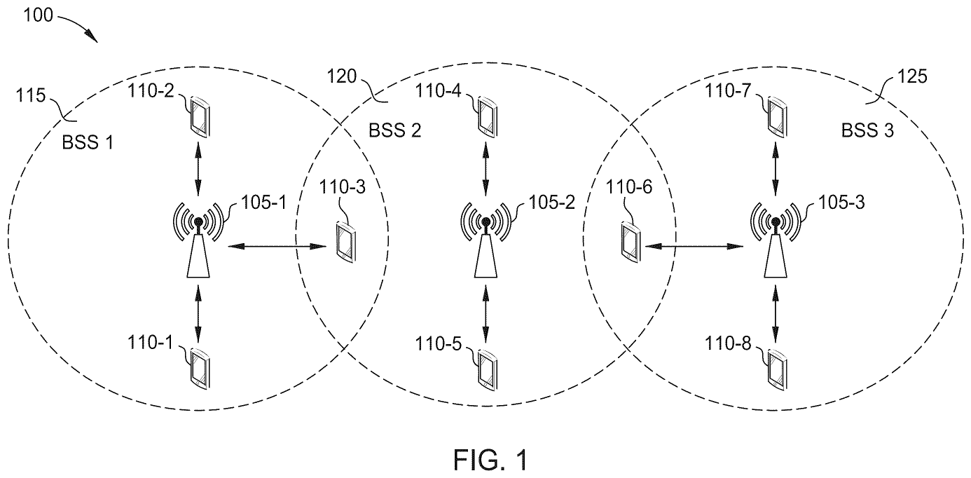

FIG. 1 depicts an example wireless network environment 100 that supports adaptive adjustment of MAPC mode, according to some embodiments of the present disclosure.

In the illustrated network environment 100, three basic service sets (BSSs) are depicted, including BSS 1 (115), BSS 2 (120), and BSS 3 (125). Each BSS includes one access point (AP) and several associated stations (STAs). For example, BSS 1 includes AP 105-1 and STAs 110-1, 110-2, and 110-3, BSS 2 includes AP 105-2 and STAs 110-4 and 110-5, and BSS 3 includes AP 105-3 and STAs 110-6, 110-7 and 110-8.

Geographical overlaps between BSS 2 with BSS 1 and BSS 3 suggest potential interference situations where BSS 2 may be subjected to interference from the neighboring BSSs (and vice versa). For example, STA 110-4 may experience interference or competition for medium access from multiple sources: STAs within the same BSS, like STA 110-5, or STAs associated with neighboring BSSs, like STA 110-3 in BSS 1 or STA 110-6 in BSS 3. To mitigate co-channel interference and optimize spatial reuse opportunities, any devices within the three BSSs (e.g., BSS 1, BSS 2, and BSS 3) may form a coordination group (CG) for multi-AP coordination. Within this CG, each AP may select a specific MAPC mode to effectively manage the shared wireless medium. In some embodiments, the MAPC mode selection may be determined based on the SCS targets (or requirements) of the traffic flows between the AP (e.g., AP 105-2) and its associated STAs (e.g., STA 110-4).

In the illustrated environment 100, each STA, such as STA 110-4, may utilize the stream classification service (SCS) to determine the specific network quality targets (or requirements), such as reliability targets or latency targets, for each traffic flow it handles. The STA (e.g., STA 110-4) may then communicate these SCS-identified targets to its associated AP (e.g., AP 105-2). Following that, the AP (e.g., AP 105-2) may select an appropriate MAPC model that aligns with these SCS-identified targets. For example, if STA 110-4 is handling traffic flows that demand ultra-high reliability (e.g., an SCS flow with a reliability target of 99.9999%), AP 105-2 may decide to avoid multi-AP coordination-spatial reuse (MAPC-SR) mode due to its potential for variations in SINR (which could introduce errors), and/or allocate interference-free TXOPs to STA 110-4 to ensure uninterrupted services. If the traffic flows handled by STA 110-4 are latency-sensitive (e.g., an SCS flow with a latency target of less than 10 milliseconds), AP 105-2 may give priority to STA 110-4 in multi-AP coordination-time division multiple access (MAPC-TDMA) mode transmissions, and/or limit the usage of legacy Wi-Fi access methods that typically do not support advanced QoS features (to ensure that latency-sensitive traffic is not delayed by less time-critical data).

In some embodiments, such as when a STA is primarily handling a single type of traffic, its associated AP may select the MAPC mode that matches the specific SCS-identified targets (or requirements) of that traffic type. For example, if STA 110-4 is engaged in real-time video conferencing, which relies on both high reliability and low latency, AP 105-2 may prioritize the traffic by selecting a MAPC mode (like MAPC-TDMA) that can minimize latency through scheduled TXOPs.

In some embodiments, such as when a STA like STA 110-4 is managing multiple types of traffic concurrently, each with unique SCS-identified targets (or requirements), the associated AP like AP 105-2 may use a more nuanced strategy that can accommodate the diverse needs. In some embodiments, the associated AP, such as AP 105-2, may prioritize traffic based on the traffic criticality, sensitivity of each flow, or associated application requirements. For example, when STA 110-4 is handling real-time communication traffic (e.g., for real-time video conferencing) and bulk data transfer traffic (e.g., for file uploading/downloading) concurrently, the AP 105-2 may prioritize the real-time communication traffic over the bulk data transfer. Following the determination that one traffic type is more important (e.g., with higher priority) than others, AP 105-2 may select an MAPC mode that supports the SCS-identified targets (such as reliability targets or latency targets) of the primary traffic type (e.g., the traffic with the highest priority). For example, if real-time communication traffic (e.g., for real-time video conferencing) is identified as the primary traffic type, despite the presence of other less sensitive traffic, AP 105-2 may still choose a MAPC mode (like MAPC-TDMA) that favors low latency to ensure the quality of the video call.

The AP's ability to dynamically select and adjust MAPC modes based on the traffic type and corresponding SCS-identified targets (or requirements) can effectively maintain the service quality between the AP and its associated STAs. Such flexibility is particularly beneficial in the depicted multi-AP coordination environment 100, where multiple APs (e.g., AP 105-1, 105-2, and 105-3) and overlapping coverage areas may lead to significant co-channel interference. By intelligently managing and adjusting the MAPC modes, the AP ensures that the traffic stream handled by its associated STA, whether it is a single stream or the primary one within multiple concurrent streams, receives the necessary network resources and conditions to meet its respective SCS targets.

After the MAPC mode is selected, in some embodiments, STAs, such as STA 110-4, may actively track the impact of the chosen mode on their traffic streams, especially focusing on how well the SCS-identified reliability and latency targets are being met during MAPC operation. The STA 110-4 may track its performance using various metrics and report the data to its associated AP 105-2. The performance metrics may include, but are not limited to, signal strength, packet loss rate, throughput, and observed latency. By analyzing these performance metrics, AP 105-2 may observe and identify any changes or degradation in the performance of the traffic streams that could be attributed to the MAPC mode in operation, its capacity constraints, or interference caused by other devices.

Following the identification of any degradation, in some embodiments, the AP 105-2 may request MAPC measurements from STA 110-4. In some embodiments, the AP, like AP 105-2, may provide the reporting STA, like STA 110-4, a list of identifiers (e.g., overlapping BSS (OBSS) BSSIDs or BSS Colors) to highlight potential sources of interference with the STA 110-4's traffic flows. Within the depicted environment 100, the list may identify STA 110-3 and STA 110-6 as the potential sources of interference, as STA 110-3 is located within the overlapping area between BSS 1 and BSS 2, and STA 110-6 is located within the overlapping area between BSS 2 and BSS 3. The positions of these STAs lead to a higher likelihood of co-channel interference with STA 110-4 within BSS 2, due to the proximity and direct overlap in the areas served by the respective APs.

Utilizing the list and the identifiers included, in some embodiments, STA 110-4 may then observe each device's (like STA 110-3 and STA 110-6) interference impacts during its scheduled TXOPs (e.g., tracking TXOPs utilized by devices in OBSSs, which therefore prevents STA 110-4 from accessing the channel). In some embodiments, STA 110-4 may use relevant metrics (e.g., the percentage of TXOPs taken by other devices in OBSSs, the number of failed transmission attempts, changes in SINR) to quantify the extent of interference and its impact on network performance. STA 110-4 may then report the OBSS-specific observations of interference to AP 105-2, providing detailed information about the interference caused by devices in specific BSSIDs or BSS colors. For example, AP 105-2 may instruct STA 110-4 to closely monitor and track the interference impacts attributable to STA 110-3 and STA 110-6, respectively. Such detailed monitoring may involve observing how many TXOPs, initially scheduled for STA 110-4, were interfered with by the activities of either STA 110-3 or STA 110-6, preventing STA 110-4 from accessing the medium as planned. This observation helps in assessing how these interferences affect the reliability and quality of STA 110-4's data transmission.

With the OBSS-specific interference data, in some embodiments, AP 105-2 may conduct a detailed analysis to refine its transmission strategy, such as changing the current MAPC mode, or implementing relevant interference mitigation techniques (e.g., adjusting transmit power, altering TXOPs allocation) for each source of interference. These adjustments are implemented to optimize STA 110-4's network performance, to ensure an optimal (or at least improved) match between the characteristics of the traffic stream (whether it is a single stream or the primary one within multiple concurrent streams) managed by STA 110-4 and the MAPC modes that best satisfy the SCS targets (e.g., reliability targets, latency targets) of the traffic stream.

In some embodiments, upon detecting any degradation in the performance of STA 110-4, AP 105-2 may instruct STA 110-4, instead of requesting MAPC measurements on specific devices (identified through BSSIDs or BSS colors), to monitor general OBBS interference. Such general monitoring may include observing the occurrence of TXOPs, originally scheduled to STA 110-4, that were occupied by other STAs, without distinguishing which specific STA causes the interference. This approach may be implemented when the STAs lack the hardware or software capabilities to distinguish interference from different devices.

The collected general interference data may then be transmitted to AP 105-2, which utilizes machine learning (ML) model(s) to analyze and differentiate the sources of interference and their impacts. For example, if STA 110-4 reports that 40% of its TXOPs were taken by other devices, the ML models may identify that STA 110-3 is responsible for 30% of the interference, while STAs 110-5 and 110-6 each contribute 5%. The ML model(s) are trained to correlate a variety of input features to one or more target features. Input features may include observed SCS degradation of the STA 110-4, general OBSS interference data, and the specific MAPC modes operating on each OBSS AP (such as AP 105-1, AP 105-2, and AP 105-3). The target features for the ML model(s) may include the identification of specific interference sources and/or their detected impacts on network performance. During the training phase, the model may be provided with a dataset comprising these input features along with known outcomes based on historical data. The training process allows the model(s) to learn the complex relationships between the network's configurations, the presence of OBSSs, and the resulting performance impacts. Once trained, the ML model(s) may be applied in real-time to analyze current network data, classify interference sources, and estimate their impacts. Based on the identified interference sources and impacts, AP 105-2 may dynamically adjust the MAPC mode, and/or implement relevant interference mitigation measures. As discussed above, the adjustments may be adopted to enhance the STA 110-4's network performance, and ensure the most suitable MAPC mode is selected (one that aligns most closely with the SCS targets for the traffic streams handled by STA 110-4).

APs 105 may be wireless routers, network switches, mesh network nodes, or other devices that provide connectivity and support for various network services, including but not limited to distributing IP addresses, providing wireless access for devices, managing network traffic, and facilitating secure data transmission. STAs 110 may be stationary or mobile, and may be referred to as user devices (UEs), client devices, mobile devices, and terminals or access terminals, among others. STAs 110 may represent any devices capable of connecting to a wireless network to access services and communicate with other devices within (and/or or outside of) the network. STAs 110 may include a wide range of device types, including, but not limited to, smartphones, tablets, laptops, smart sensors, and other Internet of Things (IoT) devices.

Although the depicted environment 100 showing three BSSs is provided for conceptual clarity, in some embodiments, any number of BSSs may be involved and collectively form a CG for multi-AP coordination. Each AP within the CG may dynamically adjust its MAPC modes and implement interference mitigation measures in response to the identified SCS requirements and detected interferences across or within the group.

As discussed above, within the depicted environment 100, STAs, such as STA 110-4, may experience interference or competition for medium access from other STAs within OBSSs. In response, the STA's associated AP, like AP 105-2, may adjust its MAPC mode to better meet the SCS targets of STA 110-4's managed traffic flows. The dynamic adjustments allow for mitigating interference and/or optimizing the network conditions for STA 110-4. The explanation that uses STA 110-4 and AP 105-2 as examples is provided for conceptual clarity to illustrate how dynamic MAPC adjustments can enhance network performance. Within the depicted environment 100 where three BSSs are present, STAs within these BSSs may experience varying degrees of interference. For example, in some embodiments, STA 110-2, associated with AP 105-1, may encounter interference from STA 110-1 and/or STA 110-3. In such configurations, STA 110-2 may monitor the interference (whether OBSS-specific or general), and report its monitoring to its associated AP 105-1. In response, AP 105-1 may adjust the MAPC model and/or implement interference mitigation techniques to better satisfy the specific SCS requirements of the traffic flows handled by STA 110-2. In some embodiments, STA 110-7 may experience interference from STA 110-8 and/or STA 110-6. The associated AP 105-3 may monitor real-time interference data, and adapt its strategies to align with the SCS targets of STA 110-7's managed traffic flows.

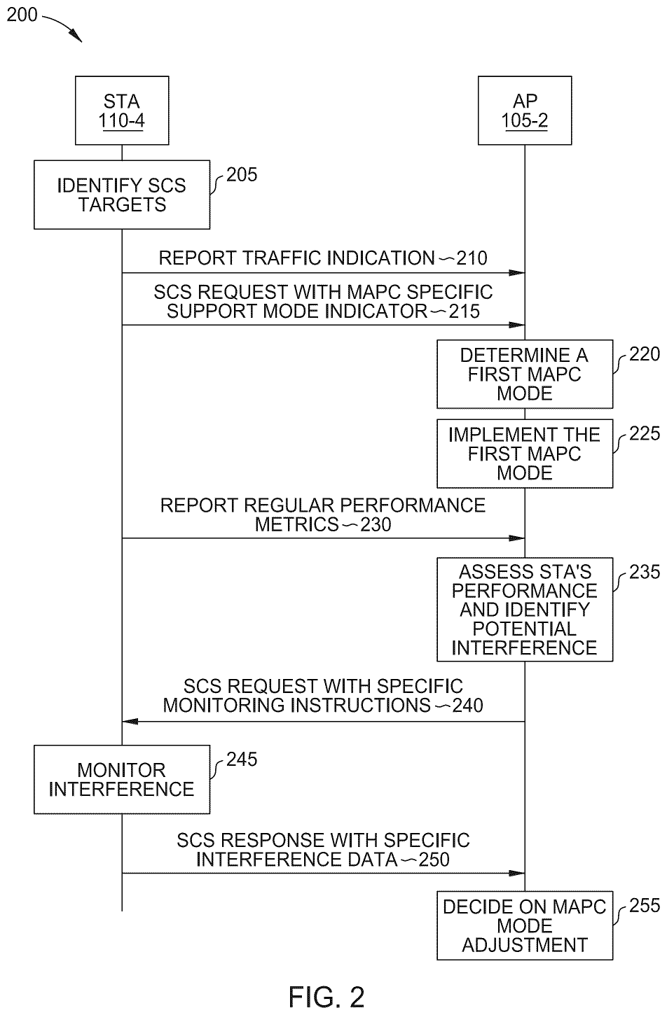

FIG. 2 depicts an example process 200 for adjusting MAPC mode based on specific interference monitoring, according to some embodiments of the present disclosure.

In the illustrated example process 200, STA 110-4 (which may correspond to STA 110-4 as depicted in FIG. 1) utilizes the SCS to examine both outgoing (or uplink) and incoming (or downlink) traffic flows to determine their traffic types, such as video, voice, or data transfer. The analysis may further include assessing the specific requirements and/or characteristics of each traffic type. In some embodiments, these requirements and/or characteristics may be defined in the QoS Characteristics Information Element (IE), which includes information like application identifiers, service priority levels, and targets for latency, jitter, and packet loss. Based on the traffic type and its characteristics, the SCS determines the SCS targets (e.g., reliability targets, latency targets, throughput targets) for each traffic flow (step 205). For example, real-time video conferencing traffic, which demands both low latency and high reliability to ensure smooth communication, may have a SCS-defined latency target set to no more than 10 milliseconds, and a reliability target set at 99.99% to ensure uninterrupted and clear video data transfer. For a background file download traffic, which requires high reliability over latency, the SCS may set the reliability target at 99.9999%, to emphasize the importance of error-free data transmission over speed.

Once the SCS identifies the targets for each traffic flow, STA 110-4 communicates this information to its associated AP 105-2 (which may correspond to AP 105-2 as depicted in FIG. 1) (step 210). In some embodiments, STA 110-4 may use specific management or control frames defined within the Wi-Fi protocols to report the SCS targets (e.g., reliability target, latency target, packet loss target). These frames may include the QoS Characteristics IE or similar information elements that detail the required service quality.

After identifying the QoS targets for each traffic flow, STA 110-4 sends a request to its associated AP 105-2, along with a MAPC specific support mode indicator (step 215). In some embodiments, the MAPC specific support mode indicator may demonstrate that the STA has the necessary software and hardware capabilities to perform OBSS-specific tracking and reporting. In some embodiments, in addition to the MAPC specific support mode indicator, the request may further include a list of MAPC modes supported by STA 110-4, and/or more specifically, indicate STA 110-4's preferred MAPC mode. For example, STA 110-4 may indicate it supports MAPC-SR, MAPC-FDMA, MAPC-OFDMA, MAPC-TDMA, and has a preference for MAPC-Coordinated TDMA (C-TDMA) mode. In some embodiments, the preferred MAPC mode may be determined based on a client-based ML analysis of past performance data that aligns with the identified SCS targets for the traffic flows. In some embodiments, the mode preference and support indication may be encapsulated within management or control frames as defined in the Wi-Fi standards. In some embodiments, the STA 110-4's per-SCS stream MAPC support and preference information may be shared with other APs within the same CG (e.g., AP 105-1 and AP 105-3 of FIG. 1) (including the leader AP and follower APs within the same CG). In some embodiments, the preference exchange between APs may be achieved through over-the-air (OTA) transmissions. Following the preference, when scheduling TXOPs for specific traffic streams, the leader AP along with follower APs in the CG may restrict the usage of MAPC modes not supported by STA 110-4, and/or prioritize the selection of STA 110-4's preferred MAPC mode.

With the confirmation of STA 110-4's capabilities to perform OBSS-specific tracking and/or the receipt of its preferred or supported MAPC modes, AP 105-2 conducts a detailed analysis (considering the reported SCS targets, the overall network conditions, and the preferred or supported MAPC modes), and selects a MAPC mode that optimally (or at least adequately) meets the STA 110-4's network needs, with a particular focus on the SCS targets identified for the STA 110-4's active traffic flows (step 220). In some embodiments, such as when the STA 110-4's request (at step 215) lists its supported MAPC modes, the AP 105-2 may limit its selection to those modes included within the list. In some embodiments, such as when the STA 110-4's request (at step 215) specifies a preferred MAPC mode (e.g., MAPC-TDMA), the decision-making process may also consider whether to adhere to the STA's preference or select an alternative MAPC mode that better aligns with the overall network conditions and the SCS targets of the STA 110-4's managed traffic streams. As discussed above, for traffic flows that require ultra-high reliability (e.g., an SCS flow with a reliability target of 99.9999%), MAPC-SR mode may be avoided due to its potential for variations in SINR, and for traffic flows that are latency-sensitive (e.g., an SCS flow with a latency target of less than 10 milliseconds), MAPC-TDMA may be selected to satisfy the stringent latency target.

When STA 110-4 is primarily handling a single type of traffic, such as real-time video conferencing, AP 105-2's selection of the MAPC mode may be directly influenced by the specific SCS targets associated with this traffic type. When STA 110-4 is managing multiple types of traffic concurrently, each with different SCS targets, AP 105-2 may evaluate the various traffic types to determine which should be given priority in the MAPC mode selection. In some embodiments, the evaluation may involve considering a wide range of factors that influence the prioritization, including traffic criticality (the importance of the traffic type for maintaining the user experience), sensitivity (the traffic's tolerance to delays, packet losses, or variations in throughput), application requirements (specific demands of the application generating the traffic), and the like. By weighting these factors, AP 105-2 may make informed decisions about which MAPC mode to select to ensure that the most critical and sensitive traffic types are prioritized to meet their specific SCS targets. For example, if STA 110-4 is engaged in both real-time video conferencing and file downloading, AP 105-2 may prioritize the video conferencing traffic due to its higher sensitivity to delays and/or greater importance for maintaining the user experience. AP 105-2 may then select the MAPC mode that is best suited to maintain the quality of the video conferencing traffic flows.

In the illustrated example, following the selection of MAPC mode, AP 105-2 implements the chosen mode to optimize STA 110-4's network performance (step 225). AP 105-2 then initiates the regular collection of performance metrics from STA 110-4 to monitor the impact of the mode adjustments (step 230). The performance metrics collected may include signal strength, throughput, latency, packet loss rate, or other parameters that reflect STA 110-4's network performance under the selected MAPC mode. Upon receiving the performance data, AP 105-2 analyzes the data to determine whether the SCS targets of STA 110-4's traffic streams have been satisfied under the selected mode (step 235). The ongoing analysis also enables AP 105-2 to monitor the STA 110-4's performance continuously, and identify any changes or degradation that indicate potential interference (step 235). For example, if the performance data shows a noticeable degradation, such as increased latency or packet loss exceeding acceptable (or predetermined) thresholds, this may indicate there are potential interferences within the CG affecting STA 110-4's connectivity and service quality. In response to the degradation, AP 105-2 may initiate further diagnostic measures to detect the sources of interference and determine their impacts.

As illustrated, AP 105-2 sends a request to STA 110-4, instructing it to specifically monitor for interference from certain BSSIDs or BSS Colors (step 240). Since STA 110-4 is located within BSS 2 (as depicted in FIG. 1), which has overlapping coverage with BSS 1 and BSS 2. Therefore, STA 110-4 may encounter interference or competition for medium access from devices within these OBSSs, such as STA 110-3 from BSS 1 or STA 110-6 from BSS 3 (as depicted in FIG. 1). Additionally, STA 110-4 may also face interference from devices within its own BSS, such as STA 110-5 (as depicted in FIG. 1). In such configurations, to facilitate targeted monitoring, AP 105-2 may provide the specific BSSIDs or BSS Colors associated with STA 110-3, STA 110-5, and STA 110-6, which enable STA 110-4 to track and report back on interference from these devices, respectively.

In the illustrated example, upon receiving these identifiers (either BSSIDs or BSS Colors), STA 110-4 begins to actively monitor interference during its scheduled TXOPs (step 245), which may include counting how many TXOPs (original scheduled for STA 110-4) were preempted by other devices, thus preventing STA 110-4 from access the medium as planned. In some embodiments, various metrics may be used to quantify the extent of interference and its impact on STA 110-4's performance. These metrics may include, but are not limited to, the percentage of TXOPs taken by each identified device, the number of failed transmission attempts, and changes in SINR. The data collected during the specific monitoring is then provided to AP 105-2 (step 250). By analyzing the data, AP 105-2 identifies the sources of interference, understands their OBSS-specific impacts, and/or takes informed actions to mitigate the interference (step 255). In some embodiments, the actions to mitigate interference may include adjusting the MAPC mode, reallocating TXOPs more effectively, or implementing specific interference mitigation techniques across the BSSs. The choice of actions AP 105-2 takes depends on whether the interference is internal (within the same BSS) or external (from devices in other BSSs), the SCS targets of STA 110-4, and/or the MAPC mode operating on other devices (like AP 105-1 and AP 105-2).

For example, the report from STA 110-4 indicates it is experiencing significant interference primarily from external BSS devices, such as STA 110-3 associated with AP 105-1 or STA 110-6 associated with AP 105-3 (as depicted in FIG. 1) (e.g., STA 110-4's report indicates that 30% of its TXOPs were taken by STAs 110-3 or 110-6, while 5% of its TXOPs were taken by STA 110-5). Additionally, APs 105-1 and 105-3 are operating in a specific MAPC mode that does not effectively mitigate this cross-BSS interference (e.g., MAPC-SR). In such configurations, AP 105-2 may decide to switch from its current MAPC mode, such as MAPC-SR, to MAPC-TDMA or MAPC-OFDMA. The MAPC-TDMA mode allows AP 105-2 to schedule TXOPs (or resource units (RUs)) more strategically, therefore minimizing (or at least reducing) the impacts of interference from STA 110-3 and STA 110-6 on STA 110-4's traffic. Such mode switches are particularly beneficial for optimizing the performance of latency-sensitive applications like video conferencing, to ensure that STA 110-4 meets its low latency targets despite the presence of external interference.

If STA 110-4, associated with AP 105-2, is already operating in MAPC-TDMA mode and continues to experience external interference, particularly from devices like STA 110-3 and STA 110-6 associated with neighboring APs (APs 105-1 and 105-3 as depicted in FIG. 1), there are several additional measures that can be taken to mitigate the interference. For example, in some embodiments, AP 105-2 may enhance coordination with neighboring APs (e.g., AP 105-1 and AP 105-3 of FIG. 1), and/or share its MAPC mode settings (e.g., via OTA) with other APs to reduce interference. In some embodiments, AP 105-2 may implement beamforming to direct the signal more precisely towards STA 110-4, improving its reception and reducing the potential for interference from outside its BSS. In some embodiments, AP 105-2 may lower its transmit power to reduce the coverage area, making its coverage area no longer overlap with neighboring BSSs while still maintaining efficient coverage for devices within BSS 2.

If the performance report from STA 110-4 indicates that the primary resource of interference originates from devices within the same BSS, such as STA 110-5, AP 105-2 may explore different mitigation strategies focusing on internal network management. In some embodiments, AP 105-2 may adjust the settings of STA 110-5 to minimize its interference with STA 110-4, such as by reducing STA 110-5's transmit power or altering its channel usage. In some embodiments, AP may implement or adjust QoS policies to prioritize the traffic of STA 110-4, or use beamforming to direct the signal more precisely towards STA 110-4.

The adjustments (at step 255), such as switching MAPC mode or implementing various mitigation techniques across or within the BSS, following the receipt of monitoring data, are implemented by AP 105-2 to maintain an optimal (or at least improved) network experience of STA 110-4. These measures ensure that the SCS-identified targets for STA 110-4's active traffic streams are met or, where possible, exceeded within the dynamic operational environment.

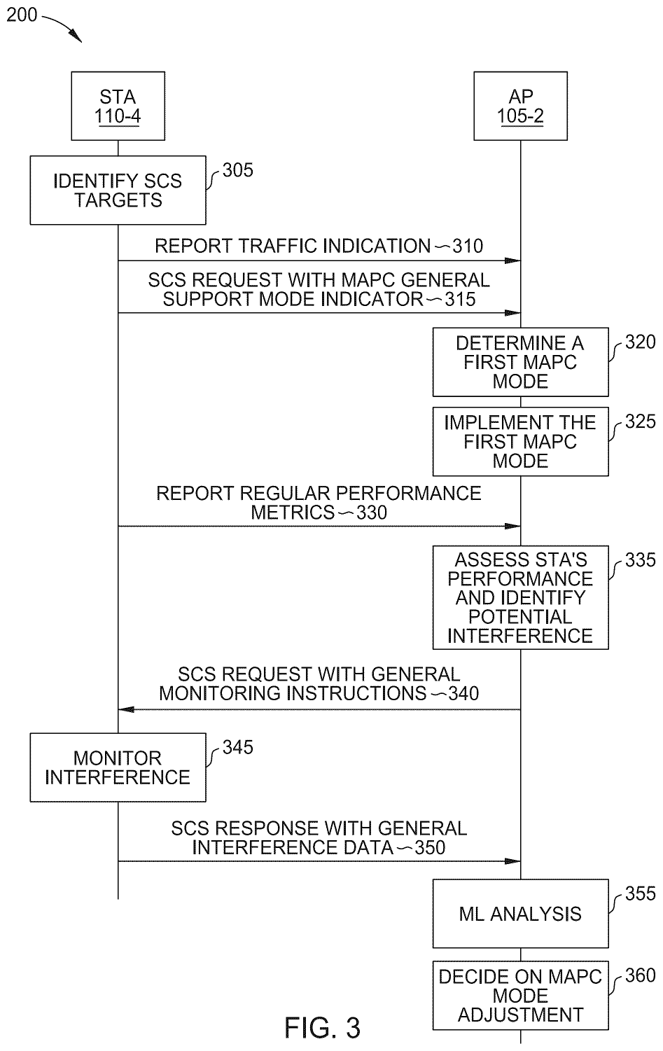

The depicted example process 200 for adjusting MAPC mode, which relies on detailed tracking and reporting from individual STAs, may only be applied to a limited number of APs or STAs that are configured with the necessary software and hardware components to perform such OBSS-specific tracking. Networks with a large number of connected devices or those lacking advanced hardware or software capacities for OBSS-specific tracking may find it challenging to implement this strategy effectively. Additionally, with the implementation of the depicted example process 200, there is a risk of overlooking sources of interference, especially in a situation where many STAs are located in the OBSSs while the AP 105-2 only provides a limited number of identifiers for tracking. If one external STA, which is not tracked because it was not included in the list of identifiers, actually contributes the most to the interference experienced by STA 110-4, this oversight may lead to a misdiagnosis of the interference sources. As a result, AP 105-2 may inaccurately attribute the majority of interference to internal STAs or to those external STAs that have been monitored. Relying on the incorrect diagnosis, the AP may implement adjustments that fail to address the primary source of interference. These limitations have been addressed by the general monitoring strategy, as depicted in FIG. 3, in which the STA 110-4 tracks general interference patterns within its operational environment, without identifying exact sources. More detail about the general monitoring strategy is discussed below with reference to FIG. 3.

FIG. 3 depicts an example process 300 for adjusting MAPC mode based on general interference monitoring and ML analysis, according to some embodiments of the present disclosure.

In the illustrated example process 300, STA 110-4 (which may correspond to STA 110-4 as depicted in FIG. 1) uses the SCS to identify the types (e.g., video, voice, or data transfer) and QoS characteristics of each uplink or downlink traffic flow. Based on the traffic type and its characteristics, STA 110-4 determines SCS targets for each traffic flow (step 305), such as reliability or latency targets, which are configured to the specific needs of each application.

As illustrated, upon determining the SCS targets, STA 110-4 transmits the information to its associated AP 105-2 (step 310), to ensure that AP 105-2 is informed of the QoS requirements for each traffic flow. In some embodiments, certain management or control frames defined in the Wi-Fi protocols may be used to report these targets. These frames may include the QoS Characteristics IE or similar information elements that detail the required service quality.

Following the report of SCS targets, STA 110-4 sends a request to AP 105-2, along with a MAPC general support mode indicator (step 315). In some embodiments, the MAPC general support indicator may be used to demonstrate that STA 110-4 is capable of performing general, non-OBSS specific monitoring. In some embodiments, the request may also include a list of MAPC modes that STA 110-4 supports, or more specifically, specify a preferred MAPC mode. In some embodiments, the preferred MAPC mode may refer to a mode that best meets the STA's SCS targets. In some embodiments, the preferred MAPC mode may be determined by executing a client-based ML model. In some embodiments, a client-based ML model may be trained by a particular client device (e.g., the STA 110-4) based on historical performance data for the client device itself, including processes such as filtering the data to identify features impacting network performance, labeling the data based on the success of meeting SCS targets, and utilizing supervised learning algorithms to correlate these features with the effectiveness of different MAPC modes (for the particular client device) under different network conditions. After training, the client-based ML model may then be applied to analyze real-time network performance data for the client device, comparing it with historical patterns, to recommend the most suitable MAPC mode for the STA's managed active traffic flows, specifically focusing on satisfying their SCS targets.

In the illustrated example, with the MAPC mode preferences and capabilities communicated by STA 110-4, AP 105-2 selects a MAPC mode that is optimally (or at least adequately) suited to meet the STA 110-4's network requirements, especially focusing on satisfying the SCS targets identified for the STA 110-4's active traffic flows (step 320). In some embodiments, such as when STA 110-4 is handling multiple different types of traffic concurrently (like video conferencing traffic and file downloading traffic), each with distinct SCS targets, AP 105-2 may identify a primary traffic (e.g., based on factors such as traffic criticality and sensitivity), and select a MAPC mode that optimally (or at least adequately) matches with the primary traffic's SCS targets. AP 105-2 then implements the selected mode, such as adjusting network parameters to align with the selected strategy (step 325). This step ensures that the network configuration is optimized to meet the SCS targets of STA 110-4's traffic flows.

In the illustrated example, AP 105-2 regularly collects performance metrics from STA 110-4 (step 330). The collected performance data enables AP 105-2 to continuously monitor the STA 110-4's network performance, such as whether the SCS targets have been satisfied under the selected mode, and/or identify potential degradation. If the performance data shows a degradation in STA 110-4's network performance, such as increased latency or packet losses exceeding acceptable thresholds, AP 105-2 instructs STA 110-4 to initiate general interference monitoring (step 340). The general interference monitoring may involve tracking interference levels without focusing on specific OBSS sources. STA 110-4, upon receiving the request, tracks the broader data on potential interference affecting its network quality (step 345). For example, STA 110-4 may monitor how many TXOPs, originally allocated to STA 110-4, are preempted by other devices (such as when STA 110-4 observes that 30% of its TXOPs are used by other devices), therefore impacting its ability to transmit data as scheduled. The tracking may not differentiate between the specific STAs causing the interference. For example, within the 30% preempted TXOPs, STA 110-4 does not distinguish how much interference is attributed to external devices located within different BSSs (e.g., STA 110-3 or STA 110-6 of FIG. 1), and how much is caused by internal devices located within the same BSS as STA 110-4 (e.g., STA 110-5 of FIG. 1). The general monitoring approach may be suited to devices that lack the advanced hardware or software capabilities required for OBSS-specific tracking.

Once STA 110-4 has collected general interference data, it reports this information to AP 105-2 (step 350). Upon receiving the data, AP 105-2 uses the ML model(s) to analyze the patterns within the broader dataset, and identify potential sources of interference (step 355). During training, the ML models may be provided with a dataset comprising a variety of input features and target features. The input features may include observed SCS degradation in STA 110-4's network performance, general OBSS interference data (e.g., the percentage of TXOPs taken by devices in OBSSs), and specific MAPC modes operating on each OBSS AP (e.g., AP 105-1, AP 105-2, and AP 105-3 of FIG. 1), while the target features may include the identification of specific interference sources and/or their detected impacts on network performance. Through the training process, the ML model(s) learns the correlation between input features and target features. During the inference phase, the ML model(s) may be applied to analyze the general interference data, identify interference sources, and estimate their impacts. For example, in some embodiments, the ML model(s) may determine whether the interference is primarily from devices within the OBSSs, such as STA 110-3 associated with AP 105-1 or STA 110-6 associated with AP 105-3 (as depicted in FIG. 1), or from devices within the same BSS as STA 110-4 (as depicted in FIG. 1). In some embodiments, the ML model(s) may even identify each source of interference and their respective impacts.

Based on the sources of interferences and impacts identified by the ML analysis, AP 105-2 takes informed actions to mitigate interference and optimize STA 110-4's network performance (step 360). For example, as discussed above, if the interference is primarily from external BSS devices, such as STA 110-3 associated with AP 105-1 or STA 110-6 associated with AP 105-3 (as depicted in FIG. 1) (e.g., STA 110-4's report indicates that 30% of its TXOPs were taken by other devices, and ML models identify that 25% of its TXOPs were taken by STAs 110-3 or 110-6), AP 105-2 may decide to switch to a MAPC mode less susceptible to the cross-BSS interference, such as MAPC-TDMA or MAPC-OFDMA. This mode adjustment may reduce the impact of cross-BSS interference by utilizing frequency resources more efficiently or by better scheduling TXOPs or resource units (RUs). Instead of or in addition to mode adjustments, in some embodiments, AP 105-2 may also engage in enhanced coordination with neighboring APs (e.g., AP 105-1 and AP 105-3 of FIG. 1) to share (or unify) MAPC mode settings and reduce interference. In some embodiments, the coordination may include AP 105-2 sharing its selected MAPC mode with neighboring APs (e.g., via OTA), and negotiating time slots or frequency channels that minimize (or at least reduce) overlap and interference between BSSs. In some embodiments, AP 105-2 may implement beamforming to direct the wireless signals more accurately towards STA 110-4 to enhance its reception. In some embodiments, such as when the primary source of interference is identified as STA 110-3, AP 105-2 may use beamforming to create a null zone (an area of reduced signal strength) towards STA 110-3's location. In some embodiments, AP 105-2 may lower its transmit power to reduce the overlapping area with neighboring BSSs, and therefore limit the potential for devices within those OBSSs to interfere with STA 110-4's data transmission. However, this reduction in coverage area may be carefully balanced with the need to maintain effective coverage for all devices within BSS 2 (as depicted in FIG. 1), to ensure that devices in BSS 2 (e.g., STA 110-5 of FIG. 1) continue to receive a strong and reliable signal for preserving network performance and user experience.

In some embodiments, if the interference is primarily from devices within the same BSS, such as STA 110-5 associated with AP 105-2 (as depicted in FIG. 1) (e.g., STA 110-4's report indicates that 30% of its TXOPs were taken by other devices, and ML models identify that 25% of its TXOPs were attributable to STAs 110-5), AP 105-2 may adopt strategies focused on internal network management. For example, in some embodiments, AP 105-2 may instruct STA 110-5 to reduce its transmit power or alter its channel usage to minimize (or at least reduce) its impact on STA 110-4. In some embodiments, AP 105-2 may prioritize STA 110-4's traffic by adjusting QoS settings, or use beamforming techniques to isolate STA 110-4's signal from STA 110-5.

In some embodiments, the general (non-OBSS specific) monitoring approach may offer a broader applicability than OBSS-specific monitoring (as depicted in FIG. 2), as not every STA or AP possesses the necessary software and hardware capabilities to track and distinguish interference from various sources. Moreover, in some embodiments, non-OBSS specific monitoring provides a more comprehensive overview of the interference within a network. Unlike OBSS-specific monitoring, where an STA may only track interference from identified sources, general monitoring captures all forms of interference affecting the STA, which includes not only the interference from known OBSS devices but also unexpected devices that may not have been initially recognized as potential sources of interference.

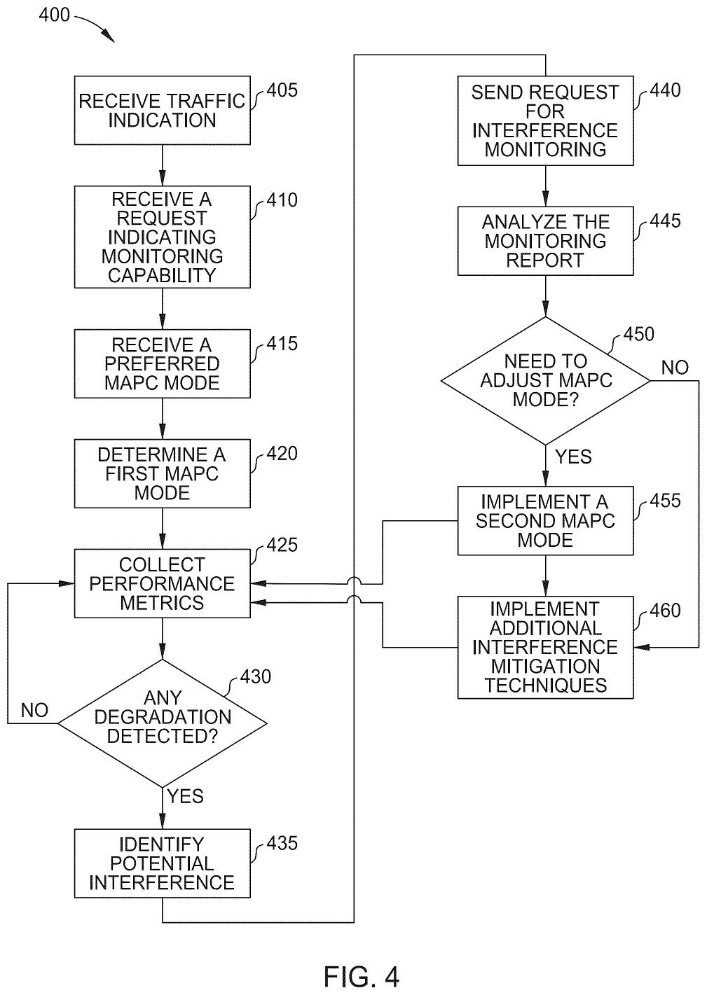

FIG. 4 depicts an example method 400 of an AP selecting and adjusting MAPC mode based on identified SCS targets and interference monitoring, according to some embodiments of the present disclosure. In some embodiments, the method 400 may be performed by one or more APs, such as APs 105-2, 105-2, and AP 105-3 as depicted in FIG. 1, and AP 105-2 as depicted in FIGS. 2 and 3. In some embodiments, the method 400 may be performed by one or more other network devices that possess the necessary capabilities for dynamic network management, such as wireless controllers (WLCs), routers, network switches, and the like.

The method begins at block 405, where an AP (e.g., AP 105-2 of FIG. 1) receives traffic indication from one of its associated STA (e.g., STA 105-4 of FIG. 1). The AP and the STA are parts of the same BSS (e.g., BSS 2 of FIG. 1). In some embodiments, the traffic indication may include SCS targets identified for each traffic flow handled by the STA. In some embodiments, the SCS targets for each traffic flow may be determined based on the type of traffic (e.g., video, voice, or data) and its QoS requirements. Different traffic flows may have different SCS targets. For example, for traffic flows associated with video conferencing applications, which demand low latency and high reliability to ensure smooth and uninterrupted communication, the latency target may be set for no more than 10 milliseconds, and the reliability target may be set to 99.99%. For traffic flows associated with file downloading, which prioritize reliability over latency, an ultra-high reliability target such as 99.9999% may be set up, while a more relaxed latency target, such as no more than 250 milliseconds, may be established. In some embodiments, the traffic indication, such as the SCS targets, may be communicated by the STA to the AP through management or control frames (defined in Wi-Fi protocols). The frames may include the QoS Characteristics IE or other relevant information elements.

At block 410, the AP (e.g., AP 105-2 of FIG. 1) receives a request from the STA (e.g., STA 105-4 of FIG. 1), indicating the STA's capabilities to perform monitoring related to interference and network performance. In some embodiments, the request may include a MAPC specific support mode indicator, which demonstrates the STA's ability to perform detailed, OBSS-specific monitoring based on identifiers like BSSIDs or BSS Colors. In some embodiments, the request may include a MAPC general support mode indicator, which shows that the STA can only perform broader, non-OBBS specific monitoring of interference across the wireless environment. Such general monitoring captures a wide range of interference impacts without pinpointing exact sources.

At block 415, the AP receives information on the STA's supported or preferred MAPC modes. In some embodiments, the supported or preferred MAPC modes may be communicated to the AP along with the request sent at block 410. In some embodiments, the supported modes may refer to the MAPC modes that the STA is technically capable of adjusting or operating within, based on its hardware and software capabilities. In some embodiments, the preferred mode may refer to the specific MAPC mode that the STA believes would best serve its traffic, particularly in meeting the SCS targets, based on its past performance. In some embodiments, the preferred mode may be determined by the STA via a client-based ML model.

At block 420, based on the information received, including SCS targets, the STA's monitoring capabilities, and preferred MAPC modes, AP 105-2 determines an MAPC mode that optimally (or at least adequately) addresses the STA's identified network needs and performance targets. In some embodiments, such as when the STA is handling multiple traffic flows concurrently, each characterized by distinct SCS targets, the AP (or the STA) may evaluate and prioritize these flows (considering factors like traffic criticality, sensitivity, or application requirements), and identify a primary traffic flow. The AP then selects the MAPC mode that aligns with the SCS targets of the primary traffic, such as meeting its latency or reliability requirements.

At block 425, the AP regularly collects performance data from the STA to monitor the quality of transmission under the selected MAPC mode. By analyzing the performance data, the AP may determine whether the SCS targets (e.g., for the STA's active traffic flows) have been satisfied. In some embodiments, the performance data may include metrics such as signal strength, latency, throughput, and packet loss rate.

At block 430, the AP analyzes the collected performance data to identify any changes or degradation. In some embodiments, the degradation in the STA's performance may include increased latency or packet loss rate that meet or exceed predetermined thresholds. If no degradation is detected, the method 400 returns to block 420 for ongoing monitoring. If degradation is detected (e.g., increased latency meeting or exceeding a defined threshold), this indicates that the STA's performance may be adversely affected by interference from other devices within the environment. The method 400 proceeds to block 435.

At block 435, the AP evaluates the wireless environment to identify potential sources of interference. For an environment having multiple BSSs, where the STA is part of one specific BSS (e.g., BSS 2 of FIG. 1) that has overlapping coverage areas with neighboring BSSs, devices located within these OBSSs (e.g., STA 110-3, STA 110-6 of FIG. 1) may cause co-channel interference, adversely affecting the STA's network performance. Furthermore, in some embodiments, the BBS to which the STA belongs may include more than one STAs. These devices (also referred to in some embodiments as internal devices) (e.g., STA 110-5 of FIG. 1) may also be sources of interference.

At block 440, the AP requests the STA to monitor interference within the environment. The interference data can help the AP to understand the extent to which the STA's ability to transmit data is being compromised by interference from other devices within the network. In some embodiments, the interference impact on the STA may be observed and/or quantified by counting how many TXOPs, originally scheduled for the STA, were preempted by other devices, directly affecting the STA's access to the medium as intended. In some embodiments, the AP may provide the STA with identifiers such as BSSIDs or BSS Colors that are associated with the potential sources of interference (identified at block 435) (e.g., STA 110-3, STA 110-5, STA 110-6 of FIG. 1). The AP may request the STA to perform detailed, OBSS-specific monitoring based on the provided identifiers. For example, when the BSSIDs for STA 110-3, 110-5, and 110-6 (as depicted in FIG. 1) are provided, STA 110-4, upon receiving these identifiers, may track the impact of each device on its network performance individually. STA 104-4 may then determine that 5% of its TXOPs were taken by STA 110-3, 5% by STA 110-5, and another 10% by STA 110-6. In some embodiments, the AP may request general monitoring when the interference sources are not well-defined or when STA indicates it can only support general tracking (at block 410). Under the general monitoring approach, the STA (e.g., STA 110-4 of FIG. 1) may report that 30% of its TXOPs were preempted by other devices, without distinguishing between specific contributors. The general monitoring data provides an overall view of the interference landscape, which enables the AP to understand the aggregated interference effects (on the STA's performance) rather than identify specific sources.

At block 445, upon receiving the interference data (either OBSS-specific or general), the AP analyzes the data to identify and understand the sources and impacts of interference on the STA's network performance. In some embodiments, such as when the interference data is general, non-OBSS specific, the AP may deploy a ML model to identify patterns and potential sources of interference within the broader dataset. The ML model may be trained to classify the interference into categories, such as external (cross-BSS) or internal, and estimate their likely sources (e.g., STAs 110-3, 110-5, and 110-6 of FIG. 1) based on the characteristics of the interference observed.

At block 450, the AP determines whether it needs to switch to another MAPC mode. A variety of factors may be considered in the decision-making process, such as the identified sources and impacts of interference (whether external, like cross-BSS, or internal), the MAPC mode operating in other BSS APs, and the STA's SCS targets and QoS requirements. The AP may determine that a mode switch or adjustment is needed when the specific interference data and/or the ML analysis (when general interference data is reported) reveal that the interference is primarily from external sources (e.g. STAs 110-3 or 110-6 of FIG. 1), and the current MAPC mode (also referred to in some embodiments as the first MAPC mode), proves to be ineffective during intense cross-BSS interference (e.g., MAPC-SR). In such configurations, the method 400 proceeds to block 455, where the AP implements a new MAPC mode. In some embodiments, the new mode may include MAPC-TDMA, MAPC-OFDMA, or other modes that offer more strategic scheduling of TXOPs and therefore effectively mitigate cross-BSS interference. If the AP determines no mode adjustment is needed—such as when the AP is already operating in a mode that strategically schedules TXOPs (e.g., MAPC-TCMA), or the interference is primarily from internal devices (e.g., STA 110-5 of FIG. 1)—the method 400 proceeds to block 460, where the AP adopts other interference mitigation techniques, such as beamforming, power adjustment, or enhanced coordination with neighboring APs.

Following either blocks 455 or 460, the method 400 returns to block 425, where the AP continues to monitor the STA's performance, to ensure that the network adjustments have effectively improved the STA's network experience to the extent satisfying or even exceeding the identified SCS targets. The continuous monitoring allows the AP to dynamically adjust its network settings in response to evolving conditions, to maintain (or enhance) the quality of service for the requesting STA.

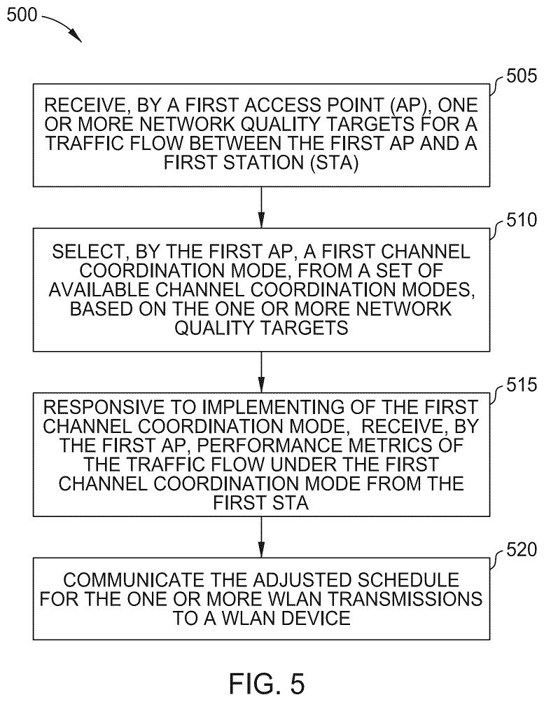

FIG. 5 is a flow diagram depicting an example method 500 for AP model selection and adjustment, according to some embodiments of the present disclosure.

At block 505, a first AP (e.g., AP 105-2 of FIG. 1) identifies one or more network quality targets for a traffic flow between the first AP and a first station (STA) (e.g., STA 110-4 of FIG. 1) (as depicted by step 210 of FIG. 2). In some embodiments, the one or more network quality targets may comprise at least one of a latency target or a reliability target of the traffic flow. In some embodiments, the one or more network quality targets for the traffic flow may be determined based at least in part on one of defined quality of service (QoS) policies or a type of the traffic flow.

At block 510, the first AP selects a first channel coordination mode, from a set of available channel coordination modes, based on the one or more network quality targets (as depicted by step 220 of FIG. 2).

At block 515, responsive to implementation of the first channel coordination mode (as depicted by step 225 of FIG. 2), the first AP receives performance metrics of the traffic flow under the first channel coordination mode from the first STA (as depicted by step 230 of FIG. 2). In some embodiments, the performance metrics of the traffic flow may comprise at least one of (i) an access delay; (ii) a packet error rate; or (iii) a throughput; or (iv) a signal strength.

At block 520, upon detecting a degradation in the performance metrics of the traffic flow (as depicted by block 430 of FIG. 4), the first AP requests the first STA to monitor interference impacts on the performance metrics of the traffic flow caused by a plurality of other STAs (as depicted by step 230 of FIG. 2). In some embodiments, the plurality of other STAs (e.g., STA 110-3, STA 110-6 of FIG. 1) may be within a proximity of the first AP that can interfere with the performance metrics of the traffic flow.

At block 525, the first AP implements an adjustment to its network configurations (as depicted by step 245 of FIG. 2). In some embodiments, the adjustment on network configurations of the first AP may comprise switching, by the first AP, to a second channel coordination mode, from the set of available channel coordination modes (as depicted by block 455 of FIG. 4).

In some embodiments, the first AP may further identify a respective interference impact caused by each respective STA, of the plurality of other STAs, using a machine learning (ML) model. In some embodiments, the ML model may be trained using historical training data comprising (a) output feature that includes identified sources of interference and (b) input features comprising at least one of the degradation in the performance metrics of the traffic flow between the first AP and the first STA, the interference impacts caused by the plurality of other STAs, or channel coordination modes operating on a plurality of other APs to which the plurality of other STAs are connected, and the ML model may be trained to correlate the input features to the output feature.

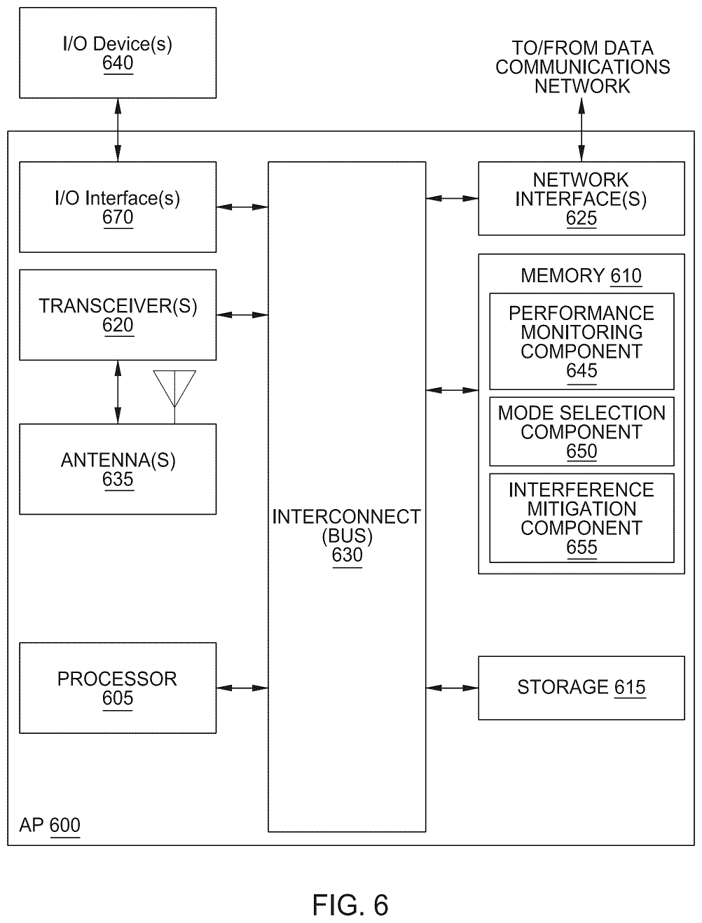

FIG. 6 depicts an example AP 600 supporting dynamic AP mode adjustment, according to some embodiments of the present disclosure. In some embodiments, the example AP 600 may correspond to the APs 105 as depicted in FIG. 1, and the AP 105-2 as depicted in FIGS. 2 and 3.

As illustrated, the example AP 600 includes a processor 605, memory 610, storage 615, one or more transceivers 620, one or more I/O interfaces 670, and one or more network interfaces 625. In some embodiments, I/O devices 640 are connected via the I/O interface(s) 670. Further, via the network interface 625, the AP 600 can be communicatively coupled with one or more other devices and components (e.g., via a network, which may include the Internet, local network(s), and the like). Each of the components is communicatively coupled by one or more buses 630. In some embodiments, one or more antennas 935 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 670, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for efficient functioning of the system.

The memory 610 may include random access memory (RAM) and read-only memory (ROM). The memory 610 may store processor-executable software code containing instructions that, when executed by the processor 605, enable the AP 600 to perform various functions described herein for wireless communication. In the illustrated example, the memory 610 includes three software components: the performance monitoring component 645, the mode selection component 650, and the interference mitigation component 655. In some embodiments, the performance monitoring component 645 may be configured to receive and analyze performance metrics from the reporting STA (e.g., STA 110-4 of FIG. 1). The performance monitoring component 645 may continuously monitor the reporting STA's network performance, tracking metrics like signal strength, latency, throughput, and packet loss. Through continuous monitoring, the performance monitoring component 645 may detect any degradation in the STA's performance that could indicate issues like interference or capacity constraints. In some embodiments, the mode selection component 650 may be configured to select the most appropriate MAPC mode to meet (or exceed) the SCS targets of the reporting STA's active traffic flows. The mode selection component 650 may evaluate the SCS targets and the supported or preferred MAPC modes communicated by the reporting STA, along with the current network conditions, to select a MAPC mode that optimizes the network's ability to handle the STA's traffic effectively. In some embodiments, the interference mitigation component 655 may be configured to adjust the AP 600's network settings when a performance degradation on the reporting STA is detected. These measures may be designed to maintain (or optimize) the reporting STA's performance in light of the identified sources of interference. Based on the interference data received from the reporting STA (whether general or OBSS-specific), the component 655 may deploy targeted interference mitigation strategies. In some embodiments, the strategies may include changing the MAPC mode to one less susceptible to the identified interference. In some embodiments, in addition to or instead of switching MAPC mode, the interference mitigation component 655 may adjust the transmit power (of the AP 600 or its associated STAs), implement beamforming to focus the signal more directly on the intended recipient, and coordinate with neighboring APs to manage cross-BSS interference. The choice of mitigation measures may depend on the nature of the interference (external or internal) and the specific needs of the network environment to ensure the most effective resolution.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

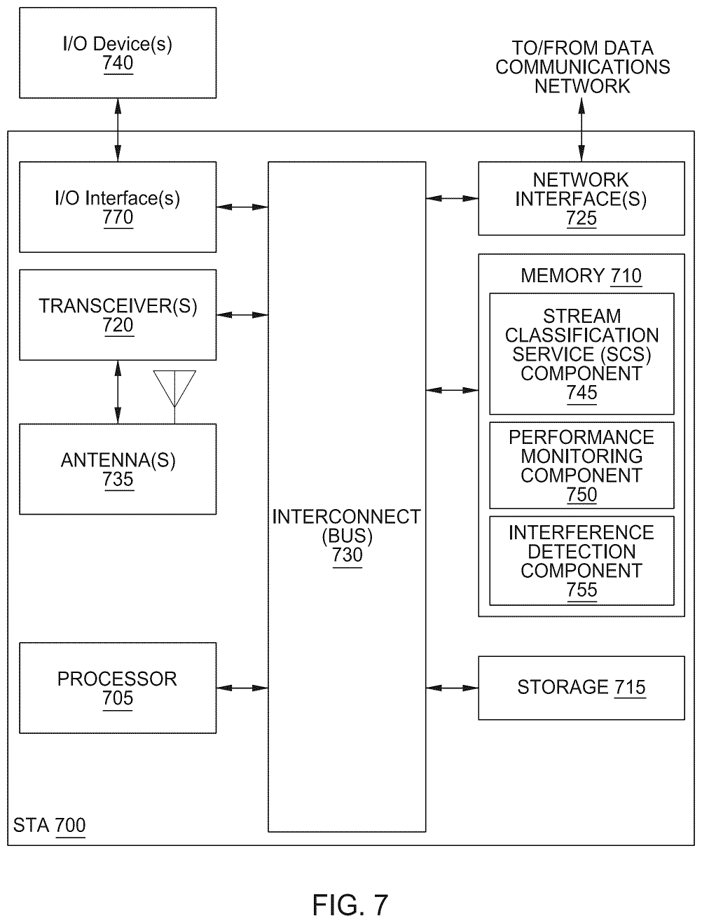

FIG. 7 depicts an example client device 700 supporting dynamic AP mode adjustment, according to some embodiments of the present disclosure. In some embodiments, the example client device 700 may correspond to the STAs 110 as depicted in FIG. 1, and the STA 110-4 as depicted in FIGS. 2 and 3.

As illustrated, the client device 700 includes a processor 705, memory 710, storage 715, one or more transceivers 720, one or more I/O interfaces 770, and one or more network interfaces 725. In some embodiments, I/O devices 740 are connected via the I/O interface(s) 770. Further, via the network interface 725, the client device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 770, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for efficient functioning of the system.

The memory 710 may include random access memory (RAM) and read-only memory (ROM). The memory 710 may store processor-executable software code containing instructions that, when executed by the processor 705, enable the device 700 to perform various functions described herein for wireless communication. In the illustrated example, the memory 710 includes three software components: the SCS component 745, the performance monitoring component 750, and the interference detection component 755. In some embodiments, the SCS component 745 may analyze the traffic flows that the example client device 700 is actively handling, and identify their types (e.g., voice, video, data transfer) and QoS characteristics. Based on the types and QOS characteristics, the SCS component 745 may determine SCS targets for each traffic flow, and communicate the information to the client device 700's associated AP. In some embodiments, the performance monitoring component 750 may be configured to continuously monitor the performance metrics of the example client device 700, including aspects such as signal strength, latency, throughput, and packet loss. The component 750 may collect these metrics in real time, and report the data to the client device 700's associated AP. The ongoing performance data may enable the AP to understand the current network condition and detect any changes or degradation. In some embodiments, the interference detection component 755 may be configured to perform interference monitoring, either general or OBSS-specific, depending on the associated AP's request and the client device 700's capabilities. In general monitoring mode, the component 755 may assess the overall interference impacts on the client device 700's performance without identifying specific sources. In OBSS-specific monitoring mode, the component 755 may utilize identifiers (e.g., BSSIDs, BSS Colors) provided by the associated AP to track and attribute interference to specific devices. The detailed interference data, whether general or specific, may help the associated AP to select effective strategies for mitigating interference and optimizing network performance.

Although depicted as a discrete component for conceptual clarity, in some embodiments, the operations of the depicted components (and others not illustrated) may be combined or distributed across any number of components. Further, although depicted as software residing in memory 710, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, by a first access point (AP), one or more network quality targets for a traffic flow between the first AP and a first station (STA);
selecting, by the first AP, a first channel coordination mode, from a set of available channel coordination modes, based on the one or more network quality targets;
responsive to implementation of the first channel coordination mode, receiving, by the first AP, performance metrics of the traffic flow under the first channel coordination mode from the first STA;
upon detecting a degradation in the performance metrics of the traffic flow, requesting, by the first AP, the first STA to monitor interference impacts on the performance metrics of the traffic flow caused by a plurality of other STAs; and
implementing an adjustment to network configurations of the first AP.

2. The method of claim 1, wherein one or more network quality targets comprise at least one of a latency target or a reliability target of the traffic flow.

3. The method of claim 1, wherein the adjustment on network configurations of the first AP comprises switching, by the first AP, to a second channel coordination mode, from the set of available channel coordination modes.

4. The method of claim 1, wherein the plurality of other STAs are within a proximity of the first AP that can interfere with the performance metrics of the traffic flow.

5. The method of claim 1, wherein the one or more network quality targets for the traffic flow is determined based at least in part on one of defined quality of service (QoS) policies or a type of the traffic flow.

6. The method of claim 1, wherein the performance metrics of the traffic flow comprises at least one of (i) an access delay; (ii) a packet error rate; or (iii) a throughput; or (iv) a signal strength.

7. The method of claim 1, further comprising identifying, by the first AP, a respective interference impact caused by each respective STA, of the plurality of other STAs, using a machine learning (ML) model.

8. The method of claim 7, wherein the ML model is trained using historical training data comprising (a) output feature that includes identified sources of interference and (b) input features comprising at least one of the degradation in the performance metrics of the traffic flow between the first AP and the first STA, the interference impacts caused by the plurality of other STAs, or channel coordination modes operating on a plurality of other APs to which the plurality of other STAs are connected, and the ML model is trained to correlate the input features to the output feature.

9. A system comprising:
one or more computer processors; and
one or more memories collectively containing one or more programs, which, when executed by the one or more computer processors, perform operations, the operations comprising:
receiving, by a first access point (AP), one or more network quality targets for a traffic flow between the first AP and a first station (STA);
selecting, by the first AP, a first channel coordination mode, from a set of available channel coordination modes, based on the one or more network quality targets;
responsive to implementation of the first channel coordination mode, receiving, by the first AP, performance metrics of the traffic flow under the first channel coordination mode from the first STA;
upon detecting a degradation in the performance metrics of the traffic flow, requesting, by the first AP, the first STA to monitor interference impacts on the performance metrics of the traffic flow caused by a plurality of other STAs; and
implementing an adjustment to network configurations of the first AP.

10. The system of claim 9, wherein one or more network quality targets comprise at least one of a latency target or a reliability target of the traffic flow.

11. The system of claim 9, wherein the adjustment on network configurations of the first AP comprises switching, by the first AP, to a second channel coordination mode, from the set of available channel coordination modes.

12. The system of claim 9, wherein the plurality of other STAs are within a proximity of the first AP that can interfere with the performance metrics of the traffic flow.

13. The system of claim 9, wherein the one or more network quality targets for the traffic flow is determined based at least in part on one of defined quality of service (QoS) policies or a type of the traffic flow.

14. The system of claim 9, wherein the performance metrics of the traffic flow comprises at least one of (i) an access delay; (ii) a packet error rate; or (iii) a throughput; or (iv) a signal strength.

15. The system of claim 9, wherein the one or more programs, which, when executed on any combination of the one or more computer processors, performs the operations further comprising identifying, by the first AP, a respective interference impact caused by each respective STA, of the plurality of other STAs, using a machine learning (ML) model.

16. The system of claim 15, wherein the ML model is trained using historical training data comprising (a) output feature that includes identified sources of interference and (b) input features comprising at least one of the degradation in the performance metrics of the traffic flow between the first AP and the first STA, the interference impacts caused by the plurality of other STAs, or channel coordination modes operating on a plurality of other APs to which the plurality of other STAs are connected, and the ML model is trained to correlate the input features to the output feature.

17. One or more non-transitory computer-readable media containing, in any combination, computer program code that, when executed by a computer system, performs operations comprising:
receiving, by a first access point (AP), one or more network quality targets for a traffic flow between the first AP and a first station (STA);
selecting, by the first AP, a first channel coordination mode, from a set of available channel coordination modes, based on the one or more network quality targets;
responsive to implementation of the first channel coordination mode, receiving, by the first AP, performance metrics of the traffic flow under the first channel coordination mode from the first STA;
upon detecting a degradation in the performance metrics of the traffic flow, requesting, by the first AP, the first STA to monitor interference impacts on the performance metrics of the traffic flow caused by a plurality of other STAs; and
implementing an adjustment to network configurations of the first AP.

18. The one or more non-transitory computer-readable media of claim 17, wherein one or more network quality targets comprise at least one of a latency target or a reliability target of the traffic flow.

19. The one or more non-transitory computer-readable media of claim 17, wherein the adjustment on network configurations of the first AP comprises switching, by the first AP, to a second channel coordination mode, from the set of available channel coordination modes.

20. The one or more non-transitory computer-readable media of claim 17, wherein the computer program code that, when executed by the computer system, performs the operations further comprising identifying, by the first AP, a respective interference impact caused by each respective STA, of the plurality of other STAs, using a machine learning (ML) model.
